(19) United States
(12) Patent Application Publication
(10) Pub. No.: US 2025/0374147 A1
(43) Pub. Date: Dec. 4, 2025

(54) RADIO FREQUENCY/OPTICAL WIRELESS COMMUNICATION SYSTEM, RADIO FREQUENCY/OPTICAL WIRELESS COMMUNICATION METHOD, MOBILE TERMINAL DEVICE, AND MOBILE TERMINAL PROGRAM

(71) Applicant: NTT, Inc., Tokyo (JP)

(72) Inventors: Ryota SHIINA, Musashino-shi, Tokyo (JP); Toshiro Nakahira, Musashino-shi, Tokyo (JP); Takuto Arai, Musashino-shi, Tokyo (JP); Tatsuhiko Iwakuni, Musashino-shi, Tokyo (JP)

(21) Appl. No.: 18/876,304

(22) PCT Filed: Jun. 23, 2022
(86) PCT No.: PCT/JP2022/025068

§ 371 Date: Dec. 18, 2024

(51) Int. Cl. H04W 36/14; H04W 88/06

(52) U.S. Cl. CPC H04W 36/144; H04W 88/06

(57) ABSTRACT

The present disclosure provides an RF/lightwave communication system C in which a mobile terminal device M transmits a broadcast in a lightwave region and a layer 2 in a case of performing communication with an RF access point R, a lightwave access point L1 or L2 that receives the broadcast in the lightwave region and the layer 2 returns a response packet in the lightwave region and the layer 2 to the mobile terminal device M, and the mobile terminal device M performs switching of a communication path from the RF access point R to the lightwave access point L1 or L2 that is allowed to return the response packet in the lightwave region and the layer 2 in a case where the mobile terminal device M is allowed to receive the response packet in the lightwave region and the layer 2.

### TECHNICAL FIELD

The present disclosure relates to a technique for switching a communication path between a radio frequency (RF) region and a certain lightwave region from infrared rays to ultraviolet rays.

### BACKGROUND ART

In an RF region (for example, an RF region of 3 THz or lower), there is a concern of a shortage of frequency resources, and in a lightwave region (for example, a lightwave region of 3 THz or higher), development of frequency resources has been proposed. Here, the RF region is not available without permission, and the lightwave region is available without permission.

In the RF region, diffraction is strong and narrowband communication in a wide range can be realized. On the other hand, in the lightwave region, propagation is strong and broadband communication in a specific region can be realized, In recent years, a system that uses both of an RE region and a lightwave region as a communication medium by combining the regions has been proposed.

However, in a system in which an RF region and a lightwave region are combined, propagation in the lightwave region is strong. For this reason, in a case where a lightwave is blocked or a terminal moves, frequent switching of a communication path is required. Therefore, in order to realize stable communication while maintaining a throughput, high-speed switching of a communication path is a problem depending on a situation in which a lightwave is blocked or a terminal moves.

### CITATION LIST

### Non Patent Literature

Non Patent Literature 1: H. Haas et al., “Introduction to indoor networking concepts and challenges in LiFi”, in Journal of Optical Communications and Networking, vol. 12, no. 2, pp. A190-A203, February 2020.
Non Patent Literature 2: R. Shiina, K. Hara, T. Taniguchi, T. Nakahina, T. Murakami and S. Ikeda, “VLC/RF Channel Switching Process Adapting to User Mobility in Coexistence Architecture”, 2019 24th OptoElectronics and Communications Conference (OECC), 2019, WA3-3.

### SUMMARY OF INVENTION

### Technical Problem

FIG. 1 and FIG. 2 illustrate processing content of the RF/lightwave communication systems of Non Patent Literatures 1 and 2. The RF/lightwave communication system C sets a communication path between a network N and an RF access point R or lightwave access points L1 and L2 by using a switch S. A coverage of the RF access point R includes coverages of the lightwave access points L1 and L2. A mobile terminal device M moves from the coverage of the lightwave access point L1, moves out of the coverage of the lightwave access point L1, and moves to the coverage of the lightwave access point L2.

In Non Patent Literatures 1 and 2, when the mobile terminal device M is located in the coverage of the lightwave access point L1, the mobile terminal device M performs communication with the lightwave access point L1. Next, when the mobile terminal device M moves out of the coverage of the lightwave access point L1, the mobile terminal device M performs communication with the RF access point R. Next, when the mobile terminal device M is located in the coverage of the lightwave access point L2, the mobile terminal device M performs communication with the lightwave access point L2.

In Non Patent Literature 1, when the mobile terminal device M moves out of the coverage of the lightwave access point L1, the mobile terminal device M determines disconnection from the lightwave access point L1 based on an observation result indicating that the throughput is significantly lower than a threshold value, and performs reconnection with the RE access point R. Next, when the mobile terminal device M enters the coverage of the lightwave access point L2, the mobile terminal device M determines disconnection from the RF access point R based on an observation result indicating that the throughput is slightly lower than a threshold value, and performs reconnection with the lightwave access point L2.

In Non Patent Literature 1, in order to distinguish between an instantaneous decrease in the observed throughput and a long-term decrease in the observed throughput, averaging processing of the observed throughput is performed, For this reason, since a certain waiting time is required to determine that the observed throughput is lower than the threshold value, there is a problem that the disconnection time becomes long.

In Non Patent Literature 2, when the mobile terminal device M moves out of the coverage of the lightwave access point L1, the mobile terminal device M predicts disconnection from the lightwave access point L1 based on a prediction result (using illuminance) indicating that the throughput is lower than a threshold value, and performs reconnection with the RF access point R. Next, when the mobile terminal device M enters the coverage of the lightwave access point L2, the mobile terminal device M predicts disconnection from the RF access point R based on a prediction result (using illuminance) indicating that the throughput is higher than the threshold value, and performs reconnection with the lightwave access point L2.

In Non Patent Literature 2, since a certain waiting time is not required to determine that the predicted throughput is lower than the threshold value, there is no problem that the disconnection time becomes long. However, when performing communication with one of the RF access point R and the lightwave access points L1 and L2, the mobile terminal device M is disconnected from the other access points. As a result, since reconnection is required when performing handover, there is a problem that a time from determination of a switching destination of the communication path to the actual start of communication becomes long (Non Patent Literature 1 also has a similar problem).

Therefore, in order to solve the above problems, an object of the present disclosure is to reduce the total of a time for determining a switching destination of the communication path and a time until communication is actually started by performing switching of the communication path between the RF region and the lightwave region.

### Solution to Problem

In order to solve the above problems, when performing communication with one of the RF access point and the lightwave access points, the mobile terminal device attempts to maintain the connection with the others. Therefore, the mobile terminal device does not need reconnection when performing handover.

Specifically, according to the present disclosure, there is provided an RF/lightwave communication system including: an RF access point for an RF region; a lightwave access point for a certain lightwave region from infrared rays to ultraviolet rays; and a mobile terminal device that is movable and performs communication with any one of the RF access point and the lightwave access point, in which the mobile terminal device transmits a broadcast in the lightwave region and a layer 2 in a case of performing communication with the RF access point, the lightwave access point that receives the broadcast in the lightwave region and the layer 2 returns a response packet in the lightwave region and the layer 2 to the mobile terminal device, and the mobile terminal device performs switching of a communication path from the RF access point to the lightwave access point that is allowed to return the response packet in the lightwave region and the layer 2 in a case where the mobile terminal device is allowed to receive the response packet in the lightwave region and the layer 2.

Further, according to the present disclosure, there is provided an RF/lightwave communication method performed by an RF access point for an RF region, a lightwave access point for a certain lightwave region from infrared rays to ultraviolet rays, and a mobile terminal device that is movable and performs communication with any one of the RF access point and the lightwave access point, the method including: transmitting, via the mobile terminal device, a broadcast in the lightwave region and a layer 2 in a case of performing communication with the RF access point; returning, via the lightwave access point that receives the broadcast in the lightwave region and the layer 2, a response packet in the lightwave region and the layer 2 to the mobile terminal device; and performing, via the mobile terminal device, switching of a communication path from the RF access point to the lightwave access point that is allowed to return the response packet in the lightwave region and the layer 2 in a case where the mobile terminal device is allowed to receive the response packet in the lightwave region and the layer 2.

Further, according to the present disclosure, there is provided a mobile terminal device that is movable and performs communication with any one of an RF access point for an RF region and a lightwave access point for a certain lightwave region from infrared rays to ultraviolet rays, the mobile terminal device including: an RF interface unit that performs communication with the RF access point; a lightwave interface unit that performs communication with the lightwave access point; a link connection monitoring unit that transmits a broadcast in the lightwave region and a layer 2 and receives a response packet in the lightwave region and the layer 2 from the lightwave access point which receives the broadcast in the lightwave region and the layer 2 in a case where the RF interface unit performs communication with the RF access point; and a link connection determination/control unit that determines that a communication path is supposed to be switched from the RF access point to the lightwave access point which is allowed to return the response packet in the lightwave region and the layer 2 and performs switching of the communication path when the link connection monitoring unit is allowed to receive the response packet in the lightwave region and the layer 2.

### Advantageous Effects of Invention

As described above, according to the present disclosure, by performing switching of the communication path between the RF region and the lightwave region, it is possible to reduce the total of a time for determining a switching destination of the communication path and a time until communication is actually started.

### BRIEF DESCRIPTION OF DRAWINGS

FIG. 1 is a diagram illustrating processing content of an RF/lightwave communication system of Non Patent Literature 1.

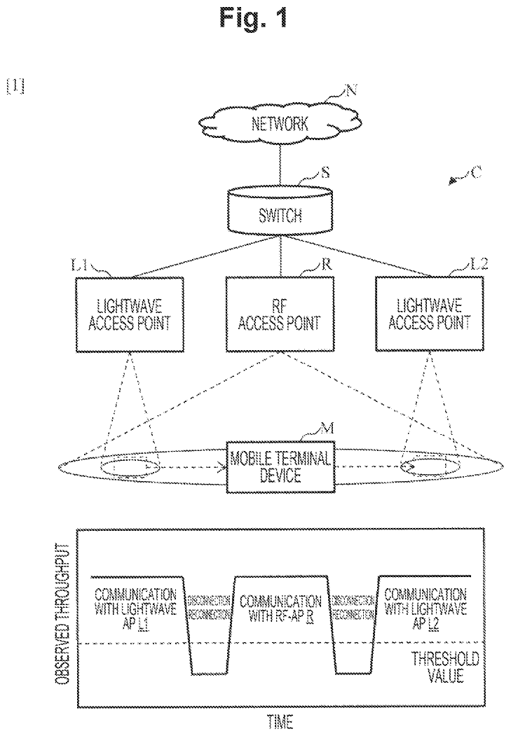

FIG. 2 is a diagram illustrating processing content of an RF/lightwave communication system of Non Patent Literature 2.

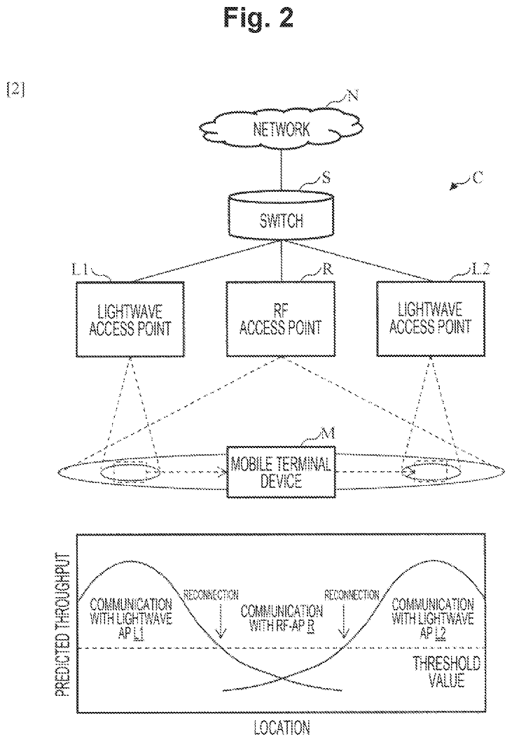

FIG. 3 is a diagram illustrating processing content of an RF/lightwave communication system of the present disclosure.

FIG. 4 is a diagram illustrating a device configuration of an RF/lightwave communication system of a first embodiment.

FIG. 5 is a diagram illustrating a processing procedure of the RF/lightwave communication system of the first embodiment.

FIG. 6 is a diagram illustrating a device configuration of an RF/lightwave communication system of a second embodiment.

FIG. 7 is a diagram illustrating a processing procedure of the RF/lightwave communication system of the second embodiment.

FIG. 8 is a diagram illustrating a processing procedure of the RF/lightwave communication system of the second embodiment.

### DESCRIPTION OF EMBODIMENTS

An embodiment of the present disclosure will be described with reference to the accompanying drawings. The embodiment to be described below is an example of the present disclosure, and the present disclosure is not limited to the following embodiment.

### Outline of RF/Lightwave Communication System of Present Disclosure

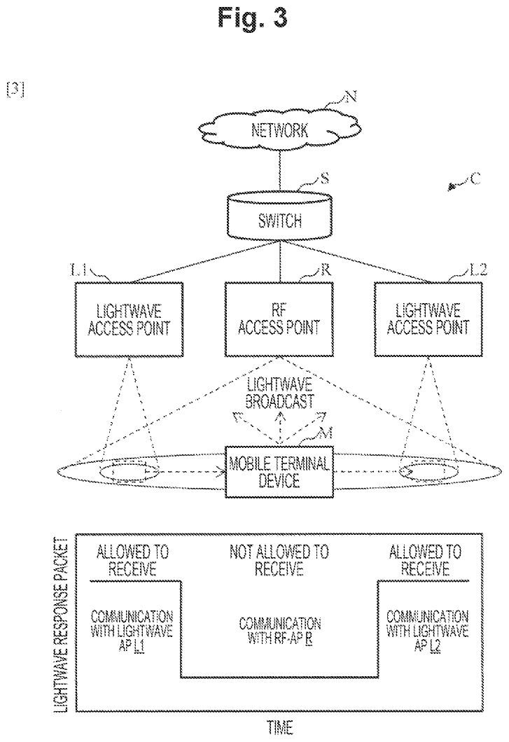

Processing content of an RF/lightwave communication system of the present disclosure is illustrated in FIG. 3. The RF/lightwave communication system C sets a communication path between a network N and an RF access point R or lightwave access points L1 and L2 by using a switch S. A coverage of the RF access point R includes coverages of the lightwave access points L1 and L2. A mobile terminal device M moves from the coverage of the lightwave access point L1, moves out of the coverage of the lightwave access point L1, and moves to the coverage of the lightwave access point L2.

In FIG. 3, when the mobile terminal device M is located in the coverage of the lightwave access point L1, the mobile terminal device M preferentially performs communication with the lightwave access point L1. Next, when the mobile terminal device M moves out of the coverage of the lightwave access point L1, the mobile terminal device M performs communication with the RF access point R. Next, when the mobile terminal device M is located in the coverage of the lightwave access point L2, the mobile terminal device M preferentially performs communication with the lightwave access point L2.

When performing communication with one of the RF access point R and the lightwave access points L1 and L2, the mobile terminal device M attempts to maintain the connection with the others. Therefore, the mobile terminal device M does not need reconnection when performing handover,

Specifically, when performing communication with the lightwave access point L1, the mobile terminal device M transmits a broadcast (specifically, refer to first and second embodiments) in the lightwave region and a layer 2. Next, in a case of receiving the broadcast in the lightwave region and the layer 2, the lightwave access point L1 returns a response packet in the lightwave region and the layer 2 to the mobile terminal device M. Next, in a case where the mobile terminal device M cannot receive the response packet in the lightwave region and the layer 2, the mobile terminal device M performs switching of the communication path from the lightwave access point L1 that cannot return the response packet in the lightwave region and the layer 2 to the RF access point R.

On the other hand, when performing communication with the RF access point R, the mobile terminal device M transmits a broadcast (specifically, refer to first and second embodiments) in the lightwave region and the layer 2. Next, in a case of receiving the broadcast in the lightwave region and the layer 2, the lightwave access point L2 returns a response packet in the lightwave region and the layer 2 to the mobile terminal device M. Next, in a case where the mobile terminal device M can receive the response packet in the lightwave region and the layer 2, the mobile terminal device M performs switching of the communication path from the RF access point R to the lightwave access point L2 that can return the response packet in the lightwave region and the layer 2.

As described above, by performing switching of the communication path between the RF region and the lightwave region, reconnection is not required when performing handover. Thereby, it is possible to reduce the total of a time for determining a switching destination of the communication path and a time until communication is actually started.

### Specific Example of RF/Lightwave Communication System of First Embodiment

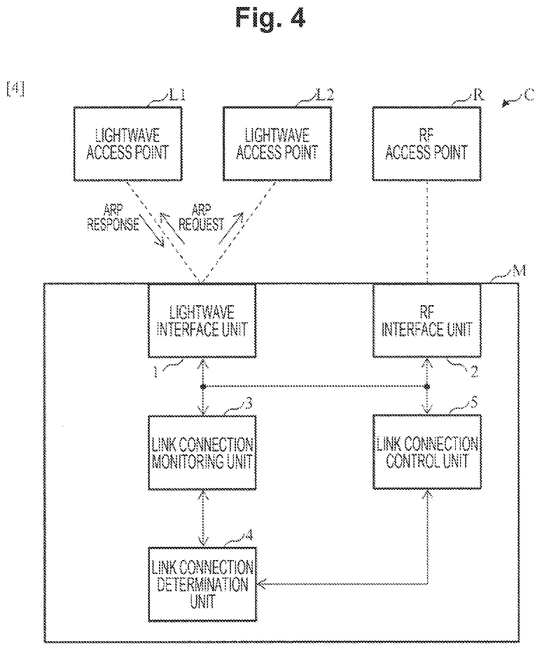

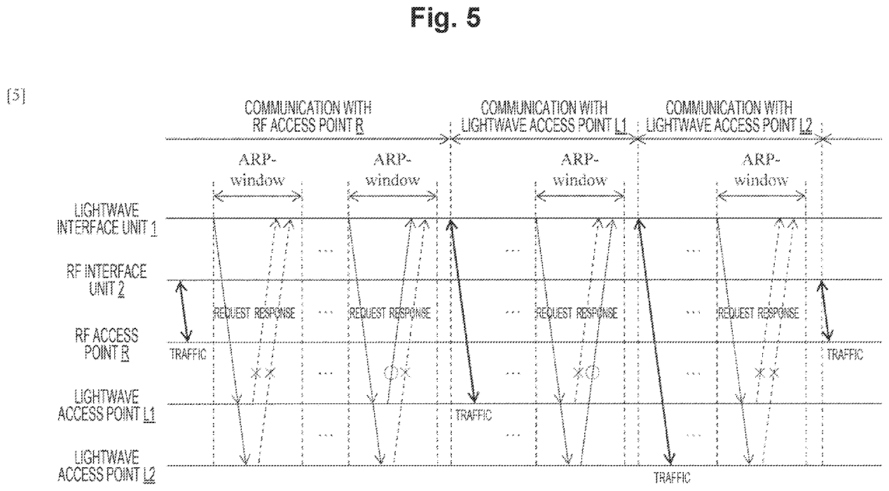

FIG. 4 illustrates a device configuration of the RF/lightwave communication system of a first embodiment. The mobile terminal device M includes a lightwave interface unit 1, an RF interface unit 2, a link connection monitoring unit 3, a link connection determination unit 4, and a link connection control unit 5. The link connection monitoring unit 3, the link connection determination unit 4, and the link connection control unit 5 can be implemented by installing a mobile terminal program for executing a processing procedure illustrated in FIG. 5 in the mobile terminal device M.

FIG. 5 illustrates a processing procedure of the RF/lightwave communication system of the first embodiment. As compared with the present disclosure, the mobile terminal device M transmits an address resolution protocol (ARP) request packet as a broadcast in the lightwave region and the layer 2. In addition, in a case of receiving the ARP request packet, the lightwave access points L1 and L2 return an ARP response packet to the mobile terminal device M as a response packet in the lightwave region and layer 2.

First, the RF interface unit 2 performs communication with the RF access point R. In addition, when the RF interface unit 2 performs communication with the RF access point R, the link connection monitoring unit 3 transmits an ARP request packet. Initially, the link connection monitoring unit 3 does not receive an ARP response packet from the lightwave access points L1 and L2 that do not receive the ARP request packet. Thereafter, the link connection monitoring unit 3 receives an ARP response packet only from the lightwave access point L1 that receives the ARP request packet.

In addition, when the link connection monitoring unit 3 can receive the ARP response packet, the link connection determination unit 4 determines that the communication path is supposed to be switched from the RF access point R to the lightwave access point L1 that can return the ARP response packet. Here, the link connection determination unit 4 may refer to an ARP table in which a MAC address and an IP address are associated with each other and that is held as cache information for a certain period of time. In addition, the link connection control unit 5 performs switching of the communication path based on the determination of the link connection determination unit 4.

Next, the lightwave interface unit 1 performs communication with the lightwave access point L1. In addition, when the lightwave interface unit 1 performs communication with the lightwave access point L1, the link connection monitoring unit 3 transmits an ARP request packet. Initially, the link connection monitoring unit 3 receives an ARP response packet only from the lightwave access point L1 that receives the ARP request packet. Thereafter, the link connection monitoring unit 3 receives an ARP response packet only from the lightwave access point L2 that receives the ARP request packet.

In addition, when the link connection monitoring unit 3 can receive the ARP response packet only from the lightwave access point L2, the link connection determination unit 4 determines that the communication path is supposed to be switched from the lightwave access point L1 to the lightwave access point L2 that can return the ARP response packet (the ARP table can be referred). In addition, the link connection control unit 5 performs switching of the communication path based on the determination of the link connection determination unit 4.

Next, the lightwave interface unit 1 performs communication with the lightwave access point L2. In addition, when the lightwave interface unit 1 performs communication with the lightwave access point L2, the link connection monitoring unit 3 transmits an ARP request packet. Initially, the link connection monitoring unit 3 receives an ARP response packet only from the lightwave access point L2 that receives the ARP request packet. Thereafter, the link connection monitoring unit 3 does not receive an ARP response packet from the lightwave access points L1 and L2 that do not receive the ARP request packet.

In addition, when the link connection monitoring unit 3 cannot receive the ARP response packet from the lightwave access point L2, the link connection determination unit 4 determines that the communication path is supposed to be switched from the lightwave access point L2 that cannot return the ARP response packet to the RF access point R (the ARP table can be referred). In addition, the link connection control unit 5 performs switching of the communication path based on the determination of the link connection determination unit 4.

In this manner, by transmitting the ARP request packet as the broadcast in the lightwave region and the layer 2, it is possible to refer to the ARP table that is held for a certain period of time. Here, a link layer discovery protocol (LLDP) broadcast or the like can be transmitted as the broadcast in the lightwave region and the layer 2, and a table function corresponding to the ARP table may be added.

### Specific Example of RF/Lightwave Communication System of Second Embodiment

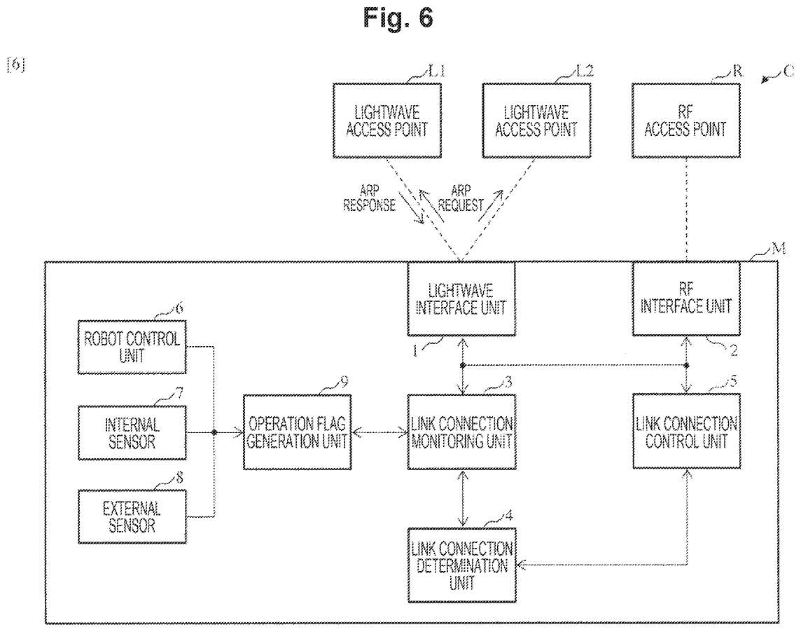

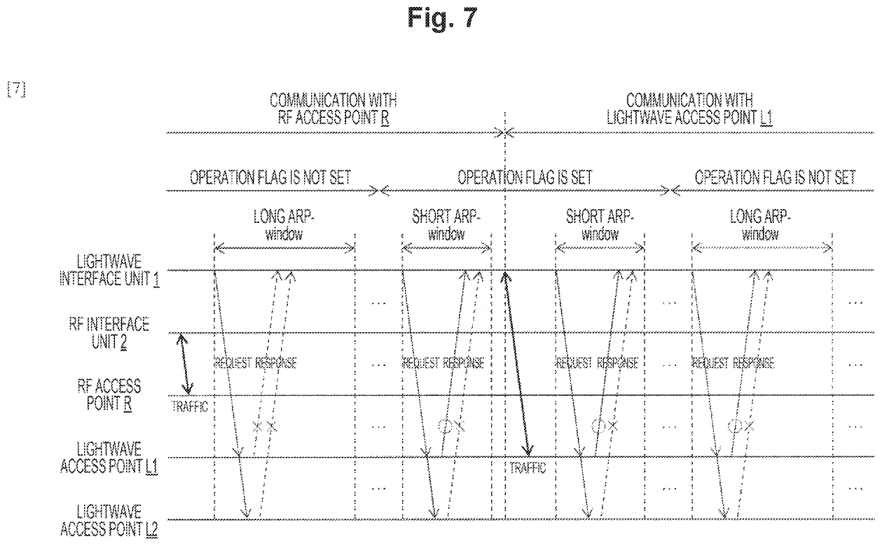

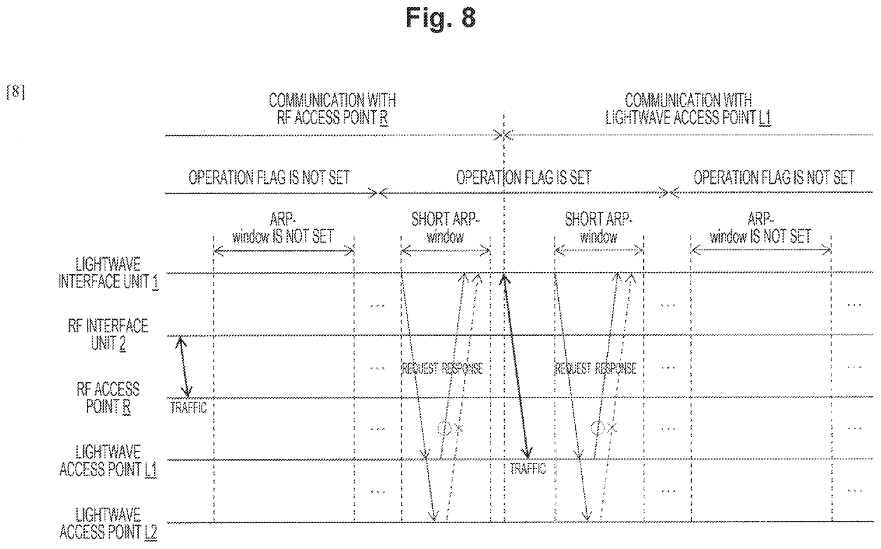

FIG. 6 illustrates a device configuration of the RF/lightwave communication system of a second embodiment. The mobile terminal device M includes a lightwave interface unit 1, an RF interface unit 2, a link connection monitoring unit 3, a link connection determination unit 4, a link connection control unit 5, a robot control unit 6, an internal sensor 7, an external sensor 8, and an operation flag generation unit 9. The link connection monitoring unit 3, the link connection determination unit 4, the link connection control unit 5, and the operation flag generation unit 9 can be implemented by installing a mobile terminal program for executing processing procedures illustrated in FIG. 7 and FIG. 8 in the mobile terminal device M.

FIG. 7 and FIG. 8 illustrate processing procedures of the RF/lightwave communication system of the second embodiment. As compared with the first embodiment, the mobile terminal device M sets a transmission interval of the broadcast in the lightwave region and the layer 2, or stops transmission of the broadcast in the lightwave region and the layer 2 according to a situation of movement of the mobile terminal device M or a possibility of movement of the mobile terminal device M.

The robot control unit 6 generates control information and the like of an operation mechanism of the mobile terminal device M as a mobile robot. The internal sensor 7 and the external sensor 8 generate operation information such as acceleration or a speed of the mobile terminal device M. The operation flag generation unit 9 generates an operation flag which is an index indicating a situation of movement of the mobile terminal device M or a possibility of movement of the mobile terminal device M based on the control information, the operation information, and the like of the mobile terminal device M. In FIG. 7 and FIG. 8, for the sake of simplicity, it is assumed that the operation flag is binary information and the operation flag is set/not set when the mobile terminal device M is moving/not moving.

In addition, when the operation flag is not set, the link connection monitoring unit 3 lengthens the interval of transmission of the ARP request packet by increasing an ARP window (in the case of FIG. 7), or stops transmission of the ARP request packet (in the case of FIG. 8). On the other hand, when the operation flag is set, the link connection monitoring unit 3 shortens the interval of transmission of the ARP request packet by decreasing the ARP window (in the case of FIG. 7), or performs transmission of the ARP request packet (in the case of FIG. 8).

First, the RF interface unit 2 performs communication with the RF access point R. In addition, when the RF interface unit 2 performs communication with the RF access point R, the link connection monitoring unit 3 transmits an ARP request packet.

Initially, the operation flag is not set, and the link connection monitoring unit 3 does not receive an ARP response packet from the lightwave access points L1 and L2 that do not receive the ARP request packet (in the case of FIG. 7). Thereafter, the operation flag is set, and the link connection monitoring unit 3 receives an ARP response packet only from the lightwave access point L1 that receives the ARP request packet (in the cases of FIG. 7 of FIG. 8).

In addition, the link connection determination unit 4 determines that the communication path is supposed to be switched from the RF access point R to the lightwave access point L1. In addition, the link connection control unit 5 performs switching of the communication path based on the determination of the link connection determination unit 4.

Next, the lightwave interface unit 1 performs communication with the lightwave access point L1, In addition, when the lightwave interface unit 1 performs communication with the lightwave access point L1, the link connection monitoring unit 3 transmits an ARP request packet.

Initially, the operation flag is set, and the link connection monitoring unit 3 receives an ARP response packet only from the lightwave access point L1 that receives the ARP request packet (in the cases of FIG. 7 of FIG. 8). Thereafter, the operation flag is not set, and the link connection monitoring unit 3 receives an ARP response packet only from the lightwave access point L1 that receives the ARP request packet (in the case of FIG. 7).

In addition, after maintaining the communication path with the lightwave access point L1, the link connection determination unit 4 determines that the communication path is not supposed to be switched. Further, the link connection control unit 5 does not perform switching of the communication path based on the determination of the link connection determination unit 4.

As described above, by setting the interval of transmission of the ARP request packet or stopping transmission of the ARP request packet according to a situation of movement of the mobile terminal device M or a possibility of movement of the mobile terminal device M, it is possible to reduce an increase in traffic of the ARP request/response packet.

### INDUSTRIAL APPLICABILITY

The RF/lightwave communication system, the RF/lightwave communication method, the mobile terminal device, and the mobile terminal program of the present disclosure can control a robot or the like that repeats stop/moving in a factory or the like.

### REFERENCE SIGNS LIST

C RF/lightwave communication system
N Network
S Switch
L1, L2 Lightwave access point
R RF access point
M Mobile terminal device
1 Lightwave interface unit
2 RF interface unit
3 Link connection monitoring unit
1 Link connection determination unit
5 Link connection control unit
6 Robot control unit
7 Internal sensor
8 External sensor
9 Operation flag generation unit

1. A radio frequency (RF)/lightwave communication system comprising:
an RF access point for an RF region;
a lightwave access point for a certain lightwave region from infrared rays to ultraviolet rays; and
a mobile terminal device that is movable and includes one or more processors configured to:
perform communication with any one of the RF access point and the lightwave access point, wherein
transmit a broadcast in the lightwave region and a layer 2 in a case of performing communication with the RF access point, wherein:
the lightwave access point is configured to receive the broadcast in the lightwave region and the layer 2 returns a response packet in the lightwave region and the layer 2 to the mobile terminal device, and
the mobile terminal device is configured to perform switching of a communication path from the RF access point to the lightwave access point that is allowed to return the response packet in the lightwave region and the layer 2 in a case where the mobile terminal device is allowed to receive the response packet in the lightwave region and the layer 2.

2. The RF/lightwave communication system according to claim 1, wherein
the mobile terminal device is configured to transmit a broadcast in the lightwave region and the layer 2 in a case of performing communication with the lightwave access point,
wherein the lightwave access point is configured to receive the broadcast in the lightwave region and the layer 2 is configured to return a response packet in the lightwave region and the layer 2 to the mobile terminal device, and
wherein the mobile terminal device is configured to perform switching of the communication path from the lightwave access point that is not allowed to return the response packet in the lightwave region and the layer 2 to the RF access point in a case where the mobile terminal device is not allowed to receive the response packet in the lightwave region and the layer 2.

3. The RF/lightwave communication system according to claim 1, wherein
the mobile terminal device is configured to transmit an address resolution protocol (ARP) request packet as a broadcast in the lightwave region and the layer 2, and
wherein the lightwave access point is configured to receive the ARP request packet and return, as a response packet in the lightwave region and the layer 2, an ARP response packet to the mobile terminal device.

4. The RF/lightwave communication system according to claim 1, wherein
the mobile terminal device is configured to set an interval of transmission of the broadcast in the lightwave region and the layer 2 or stop transmission of the broadcast in the lightwave region and the layer 2 according to a situation of movement of the mobile terminal device or a possibility of movement of the mobile terminal device.

5. A radio frequency (RF)/lightwave communication method performed by
an RF access point for an RF region,
a lightwave access point for a certain lightwave region from infrared rays to ultraviolet rays, and
a mobile terminal device that is movable and includes one or more processors configured to:
perform that is movable and performs communication with any one of the RF access point and the lightwave access point,
the method comprising:
transmitting, by the mobile terminal device, a broadcast in the lightwave region and a layer 2 in a case of performing communication with the RF access point;
returning, by the lightwave access point, a response packet in the lightwave region and the layer 2 to the mobile terminal device; and
performing, by the mobile terminal device, switching of a communication path from the RF access point to the lightwave access point that is allowed to return the response packet in the lightwave region and the layer 2 in a case where the mobile terminal device is allowed to receive the response packet in the lightwave region and the layer 2.

6. A mobile terminal device that is movable and includes one or more processors configured to perform communication with any one of a radio frequency (RF) access point for an RF region and a lightwave access point for a certain lightwave region from infrared rays to ultraviolet rays, the mobile terminal device comprising:
an RF interface configured to perform communication with the RF access point;
a lightwave interface configured to perform communication with the lightwave access point;
a link connection monitor configured to transmit a broadcast in the lightwave region and a layer 2 and receive a response packet in the lightwave region and the layer 2 from the lightwave access point which receives the broadcast in the lightwave region and the layer 2 in a case where the RF interface performs communication with the RF access point; and
a link connection determination/control configured to determine that a communication path is supposed to be switched from the RF access point to the lightwave access point which is allowed to return the response packet in the lightwave region and the layer 2 and perform switching of the communication path when the link connection monitor is allowed to receive the response packet in the lightwave region and the layer 2.

7. A non-transitory computer readable medium storing one or more mobile terminal program for causing the mobile terminal device includes one or more processors according to claim 6 to:
transmit a broadcast in a lightwave region and a layer 2 and receive a response packet in the lightwave region and the layer 2 from a lightwave access point which receives the broadcast in the lightwave region and the layer 2; and
determine that a communication path is supposed to be switched from a RF access point to the lightwave access point which is allowed to return the response packet in the lightwave region and the layer 2 and perform switching of the communication path.
